(19) United States
(12) Patent Application Publication
(10) Pub. No.: US 2016/0133381 A1
(43) Pub. Date: May 12, 2016

(54) Stationary Induction Apparatus

(71) Applicant: Hitachi, Ltd., Tokyo (JP)

(72) Inventors: Takuya OJIMA, Tokyo (JP); Akira YAMAGISHI, Tokyo (JP); Ryoji HIROBE, Tokyo (JP); Taku OYAMA, Tokyo (JP)

(21) Appl. No.: 14/921,480

(22) Filed: Oct. 23, 2015

(30) Foreign Application Priority Data
Nov. 6, 2014 (JP) 2014-225668

(51) Int. Cl. H01F 27/33

(52) U.S. Cl. CPC H01F 27/33

(57) ABSTRACT

The stationary induction apparatus includes: a static induction device main body; a tank accommodating the static induction device main body along with an insulating material; an upper stay for reinforcement and a lower stay for reinforcement provided on at least upper part and lower part of an outer surface of the tank; and a sound insulating board provided between the upper stay and the lower stay. The sound insulating board is connected to the upper stay at its one end via a first support member, and to the lower stay at another end via a second support member. The first support member is entirely joined to the upper stay, and the second support member is entirely joined to the lower stay. The sound insulating board is partially joined respectively to the first support member and to the second support member.

### CLAIM OF PRIORITY

The present application claims priority from Japanese Patent Application JP 2014-225668 filed on Nov. 6, 2014, the content of which is hereby incorporated by reference into this application.

### BACKGROUND OF THE INVENTION

1. Field of the Invention

The present invention relates to a stationary induction apparatus, and more particularly, to a stationary induction apparatus preferably having a sound insulating board on an outer surface of a tank so as to reduce noise generated from a stationary induction apparatus main body such as a transformer or a reactor.

2. Description of the Related Art

In recent years, in accordance with construction of residential area in the vicinity of a transformer substation or the like by expansion of urban area, there is an increasing demand for noise reduction in a stationary induction apparatus such as a transformer or a reactor.

The noise in the stationary induction apparatus is divided into two types of noise, i.e., noise which is generated in a core of a stationary induction apparatus main body and noise which is generated from auxiliary devices such as a ventilator and an oil transfer pump of a cooler. As the former noise, electromagnetic vibration by magnetostriction of the core is transmitted to a tank via an insulating material such as insulating oil or gas, then, it becomes noise by vibration of the tank, and is radiated to the outside. The energy of the noise by the electromagnetic vibration is overrepresented in the noise of the entire stationary induction apparatus. To prevent the noise, various measures are taken.

For example, the stationary induction apparatus is surrounded by a noise protection housing made of concrete or steel plates for sound insulation or sound absorption. Further, as a measure to reduce noise radiated from the tank in a simple manner, a sound insulating board is attached between an upper stay (an upper stay for reinforcement) and a lower stay (a lower stay for reinforcement) provided on an outer surface of the tank.

Generally in the stationary induction apparatus, as a method of sound insulation or sound absorption, the noise in the stationary induction apparatus is insulated or absorbed with the noise protection housing made of the concrete or steel plates.

The stationary induction apparatus has a tank and a stationary induction apparatus main body accommodated in the tank. The static induction device is configured with a core and a winding wound around the core. The tank is filled with an insulating material such as insulating oil or gas to cool, the stationary induction apparatus main body. An upper stay and a lower stay to reinforce the strength of a side plate forming the tank are fixed to the side plate.

In the stationary induction apparatus having this configuration, when the core is excited, electromagnetic vibration occurs in the core. When the electromagnetic vibration is transmitted to the tank via the insulating material, having a characteristic which is close to incompressibility, it is hardly attenuated. Thus the tank generates noise. To reduce the noise, a noise protection housing made of concrete or steel plates is built so as to surround the tank, to insulate or absorb the noise radiated from the tank.

Further, Patent Document 1 (Japanese Published Unexamined. Patent Application No. 2000-340432) discloses a method of attaching a sound insulating board between an upper stay and a lower stay provided on an outer surface of a tank to reduce the noise radiated from the tank.

In the method disclosed in Patent Document 1, to reinforce the strength of a side plate forming the tank, the sound insulating board made of a vibration-damping thin steel plate is attached via a thin steel plate as an elastic body to space surrounded by the upper stay and the lower stay fixed to the side plate. The noise radiated from the tank is insulated with the sound insulating board by elastic effect of the thin steel plate as a spring element and vibration suppression effect of the vibration-damping thin, steel plate, thus the noise is reduced.

### CITATION LIST

Patent Document 1: No. JP-A-2000-340432

### SUMMARY OF THE INVENTION

### Technical Problem

However, in the above-described conventional technique of surrounding the stationary induction apparatus with the noise protection housing made of concrete or steel plates for sound insulation or sound absorption, it is necessary to construct a foundation for building the concrete and steel plates. This method causes various problems such as increase in installation area of the stationary induction apparatus, increase in production cost and extension of construction period.

Further, to solve these problems, in the method of attaching the sound insulating board between the upper stay and the lower stay provided on the outer surface of the tank, when the sound insulating board is entirely welded (all-around welded) to the upper stay and the lower stay, it is difficult to sufficiently insulate the noise transmission from the welded portion and it is impossible to sufficiently reduce the noise. However, when the sound insulating board is not all-around welded but partially welded, rain and dust may enter gap(s) between the welded parts.

The present invention has been made in view of the above-described problems, and provides a stationary induction apparatus, conforming to the method of attaching a sound insulating board between an upper stay and a lower stay, in which noise is sufficiently reduced.

### Solution to Problem

To attain the above purpose, a stationary induction apparatus according to the present invention is a stationary induction apparatus including: a static induction device main body; a tank accommodating the static induction device main body along with an insulating material; an upper stay for reinforcement and a lower stay for reinforcement respectively provided on at least upper part and lower part of an outer surface of the tank; and a sound insulating board provided between the upper stay for reinforcement and the lower stay for reinforcement, wherein the sound insulating board is connected to the upper stay for reinforcement at its one end via a first support member, and to the lower stay for reinforcement at another end via a second support member, wherein the first support member is entirely joined to the upper stay for reinforcement and the second support member is entirely joined to the lower stay for reinforcement, and wherein the sound insulating board is partially joined respectively to the first support member and to the second support member.

### Advantageous Effects of Invention

According to the present invention, even in the method of attaching a sound insulating board between the upper stay and the lower stay, it is possible to sufficiently reduce noise.

### BRIEF DESCRIPTION OF THE DRAWINGS

FIG. 1 is a front view showing an example of a conventional stationary induction apparatus (transformer);

FIG. 2 is a front view showing another example of the conventional stationary induction apparatus (transformer);

FIG. 3 is a front view showing a stationary induction apparatus (transformer) according to a first embodiment of the present invention;

FIG. 4 is a partially enlarged view showing a detailed structure of attachment status of the sound insulating hoard attached to a tank of the transformer in FIG. 3; and

FIG. 5 is a partially enlarged view showing a detailed structure of the attachment status of the sound insulating board attached to the tank of the static induction device (transformer) according to a second embodiment of the present invention.

### DETAILED DESCRIPTION OF THE PREFERRED EMBODIMENTS

Hereinbelow, a stationary induction apparatus according to the present invention will be described in accordance with the illustrated embodiments. Note that in the respective figures described below, the same constituent parts have the same reference numerals.

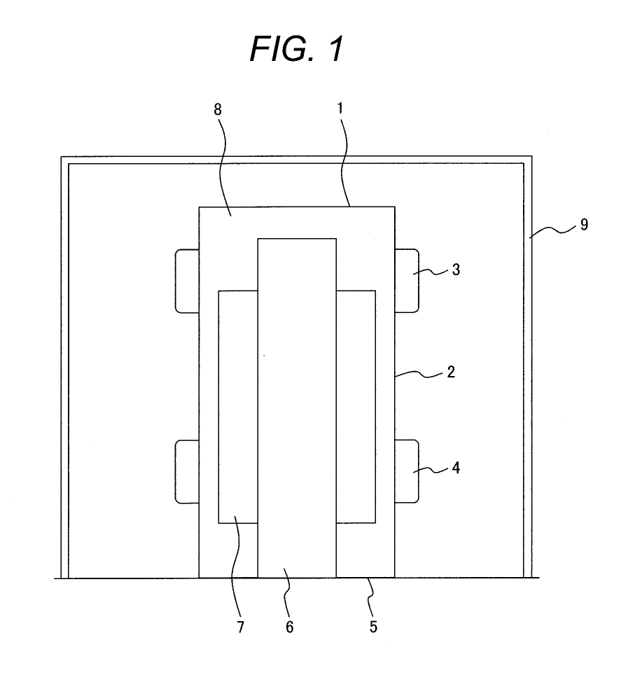

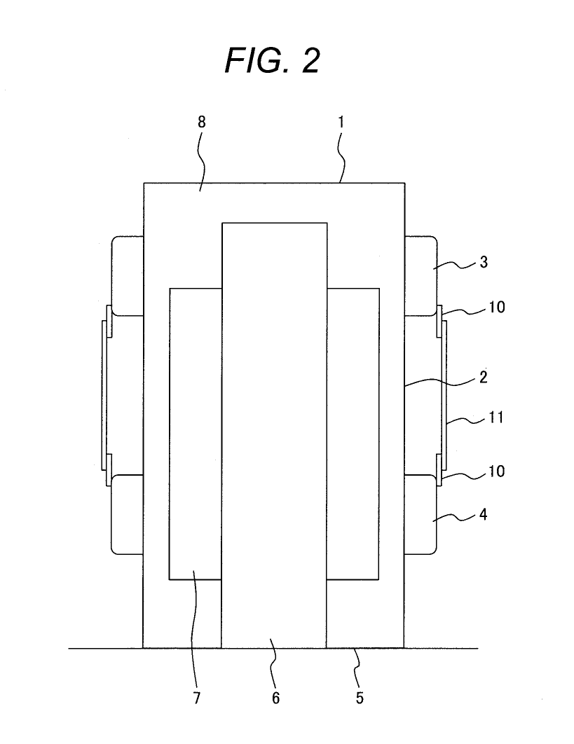

Prior to explanation of the embodiments of the present invention, as an example of a conventional stationary induction apparatus as an object of the present invention, the entire configuration of a transformer will be described using FIGS. 1 and 2.

FIG. 1 shows a method of surrounding a transformer main body by a noise protection housing made of concrete or steel plates as an example of the transformer so as to insulate or absorb noise from the transformer.

In FIG. 1, reference numeral 1 denotes a tank. A transformer 5 as an electric device main body configured with a core 6 and a winding 7 wound around the core 6 is accommodated in the tank 1. The tank 1 is filled with an insulating material 8 such as insulating oil or gas to cool the transformer 5. Numeral 2 denotes a side plate forming the tank 1. An upper stay 3 and a lower stay 4 are fixed to the side plate 2 so as to reinforce the strength of the side plate 2.

In the transformer having this configuration, when the core 6 is excited, electromagnetic vibration occurs in the core 6. The electromagnetic vibration, which is hardly attenuated via the insulating material 8 having a characteristic close to incompressibility, is transmitted to the tank 1, and the tank 1 causes noise. To reduce the noise, a noise protection housing 9 made of concrete or steel plates is constructed so as to surround the tank Thus the noise radiated from the tank is insulated or absorbed.

In the configuration of the transformer shown in FIG. 1, is necessary to construct a foundation for building the concrete or the steel plates. This method causes various problems such as increase in installation area of the trans former, increase in production cost and extension of construction period.

Further, in the example shown in FIG. 2, to reduce the noise radiated from the tank 1, a sound insulating board 11 is attached between the upper stay 3 and the lower stay 4 provided on the outer surface of the tank 1. In this method, to reinforce the strength of the side plate 2 of the tank 1, the sound insulating board 11 made of a vibration-damping thin steel plate is attached via a thin steel plate 10 as an elastic body, to space surrounded by the upper stay 3 and the lower stay 4 fixed to the side plate 2. The noise radiated from the tank 1 is insulated with the sound insulating board 11 and is reduced by elastic effect of the thin steel plate 10 as a spring element and vibration suppression effect of the vibration-damping thin steel plate.

However, in the configuration of the transformer shown in FIG. 2, when the sound insulating board 11 is entirely welded (all-around welded) to the upper stay 3 and the lower stay 4, it is difficult to sufficiently insulate the noise transmission in the welded portion and it is impossible to sufficiently reduce the noise.

The present invention has been made so as to solve this problem. Hereinbelow, the invention will be described in detail in accordance with the embodiments.

### First Embodiment

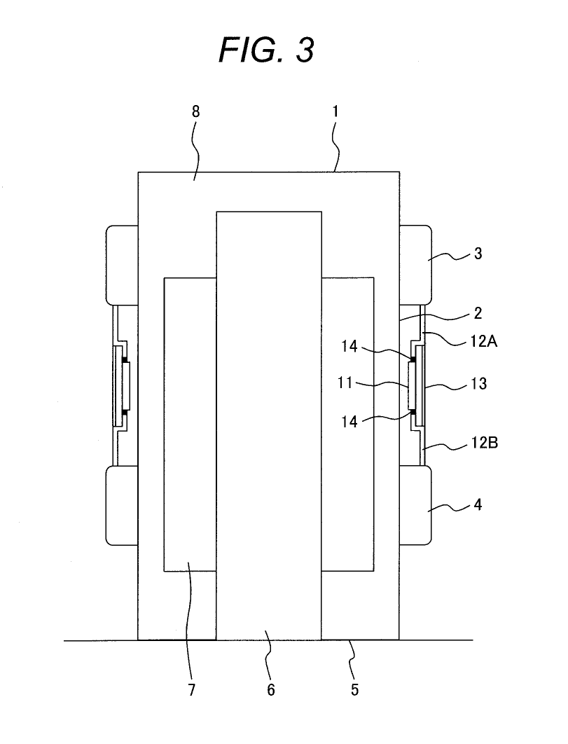

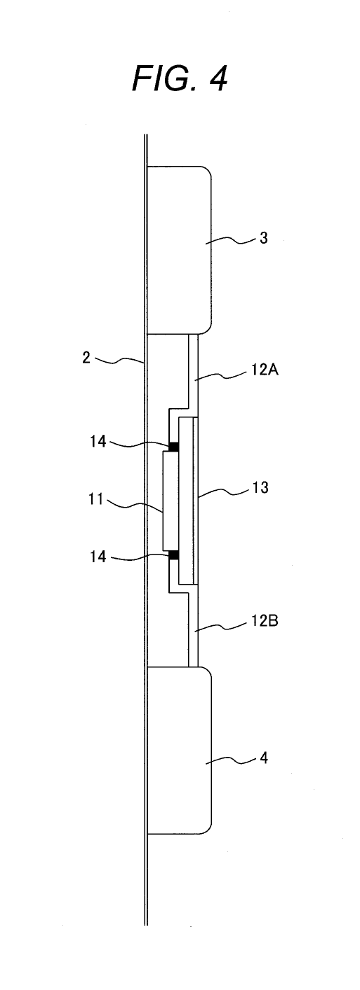

FIGS. 3 and 4 show a stationary induction apparatus (transformer) according a first embodiment of the present invention. FIG. 3 shows an entire configuration of the transformer. FIG. 4 shows a detailed structure of attachment status of a sound insulating board attached to a tank of the transformer.

As shown in these figures, the transformer according to the present embodiment is schematically configured with a transformer 5, a tank 1 accommodating the transformer 5 along with an insulating material 8, an upper stay 3 and a lower stay 4 respectively provided on at least an upper part and a lower part of an outer surface of the tank 1, and a sound insulating board 11 provided between the upper stay 3 and the lower stay 4.

In the present embodiment, the sound insulating board 11 is connected to the upper stay 3 at one end (upper end) via a first joint part (a first joint metallic part) 12A as a first support member, and to the lower stay 4 at another end (lower end) via a second joint part (a second joint metallic part) 123 as a second support member. The first joint part 12A is entirely welded (all-around welded) to the upper stay 3. The second joint part 123 is entirely welded (all-around welded) to the lower stay 4. Further, the sound insulating board 11 is partially welded (spot-welded) respectively to the first joint part 12A and the second joint part 12B (intermittent welding parts are denoted by reference numeral 14).

Further, in the present embodiment, a sealing material 13 is provided so as to cover the entire circumferential surface of the sound insulating board 11 including the intermittent welding parts 14 between the sound insulating board 11 and the first joint part 12A and between the sound insulating board 11 and the second joint part 12B. The sealing material 13 is entirely welded (all-around welded) to the first joint part 12A and the second joint part 12B.

According to the present embodiment, it is possible to prevent, the problems such as increase in installation area of noise protection housing made of concrete or steel plates, increase in production cost, and extension of construction period. Further, it is possible to sufficiently reduce noise while ensuring a sufficient area for installation of the sound insulating board 11. In addition, by covering the entire circumferential surface of the sound insulating board 11 with the sealing material 13, it is possible to prevent entrance of rain and dust from gaps between the welded parts even in the case of partial welding (spot-welding).

### Second Embodiment

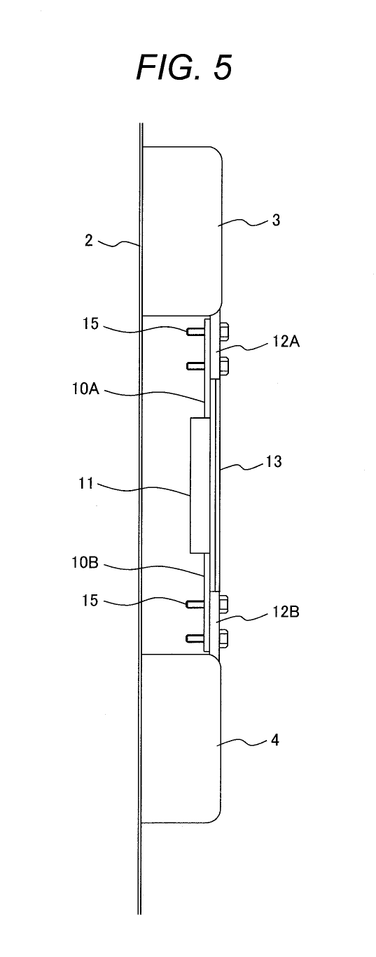

FIG. 5 shows the stationary induction apparatus (transformer) according to a second embodiment of the present invention. FIG. 5 shows a detailed structure of attachment status of the sound insulating board attached to the tank of the transformer. Since the entire configuration of the transformer is the same as that in FIG. 3 described in the first embodiment, the explanation of the entire configuration of the transformer will be omitted.

As shown in the figure, in the transformer according to the present embodiment, the sound insulating board 11 is connected to the upper stay 3 at its one end (upper end) via a first thin steel plate 10A and the first joint part 12A, and to the lower stay 4 at another end (lower end) via a second thin steel plate 10B and the second joint part 12B. The first joint part 12A is entirely welded (all-around welded) to the upper stay 3. The second joint part 12B is entirely welded (all-around welded) to the lower stay 4. The sound insulating board 11 is partially welded (spot-welded) respectively to the first thin steel plate 10A and the second thin steel plate 10B. The first thin steel plate 10A is fastened to the first joint part 12A, and the second thin steel plate 10B, to the second joint part 123, respectively with a bolt 15.

Further, in the present embodiment, the sealing material 13 is provided so as to cover the entire circumferential surface of the sound insulating board 11 including the intermittent welding parts between the sound insulating board 11 and the first thin steel plate 10A and between the sound insulating board 11 and the second thin steel plate 10B (there is no problem when the sealing material 13 is omitted). In the sealing material 13, its one end (upper end) is entirely welded to the first joint part 12A, and another end (lower end) is entirely welded to the second joint part 123.

With this configuration according to the present embodiment, it is possible to obtain the same advantage as that obtained in the first embodiment.

Note that the present invention is not limited to the above-described embodiments, and various modifications are included. The above embodiments have been described in detail for explaining the present invention, and the invention is not necessarily limited to an embodiment having all the described constituent elements. Further, a part of constituent element of an embodiment may be replaced with those of another embodiment. Further, constituent elements of an embodiment may be added to those of another embodiment. Further, it is possible to perform addition/deletion/replacement with respect to a part of constituent elements of the respective embodiments with other constituent elements.

### REFERENCE SIGNS LIST

1 . . . tank, 2 . . . side plate, 3 . . . upper stay, 4 . . . lower stay, 5 . . . transformer, core, 7 . . . winding, 8 . . . insulating material, 9 . . . noise protection housing, 10 . . . thin steel plate, 10A . . . first thin steel plate, 10B . . . second thin steel plate, 11 . . . sound insulating board, 12A . . . first joint part, 12B . . . second joint part, 13 . . . sealing material, 14 . . . intermittent welding part, 15 . . . bolt.

What is claimed is:

1. A stationary induction apparatus comprising:
a. stationary induction apparatus main body;
a tank accommodating the stationary induction apparatus main body along with an insulating material;
an upper stay for reinforcement and a lower stay for reinforcement respectively provided on at least an upper part and a lower part of an outer surface of the tank; and
a sound insulating board provided between the upper stay for reinforcement and the lower stay for reinforcement,
wherein the sound insulating board is connected to the upper stay for reinforcement at its one end via a first support member, and to the lower stay for reinforcement at another end via a second support member,
wherein the first support member is entirely joined to the upper stay for reinforcement and the second support member is entirely joined to the lower stay for reinforcement, and
wherein the sound insulating board is partially joined respectively to the first support member and to the second support member.

2. The stationary induction apparatus according to claim 1,
wherein the first support member and the second support member have a first joint part and a second joint part,
wherein the sound insulating board is connected to the upper stay for reinforcement at its one end via the first joint part, and to the lower stay for reinforcement at another end via the second joint part,
wherein the first joint part is entirely welded to the upper stay for reinforcement and the second joint part is entirely welded to the lower stay for reinforcement, and
wherein the sound insulating board is partially welded respectively to the first joint part and to the second joint part.

3. The stationary induction apparatus according to claim 2, wherein a sealing material is provided so as to cover a circumference of the sound insulating board including welding parts between the sound insulating board and the first joint part and between the sound insulating board and the second joint part.

4. The stationary induction apparatus according to claim 3, wherein in the sealing material, its one end is entirely welded to the first joint part, and another end is entirely welded to the second joint part.

5. The stationary induction apparatus according to claim 1,
wherein the first and second support members have a first thin steel plate and the first joint part and a second thin steel plate and the second joint part,
wherein the sound insulating board is connected to the upper stay for reinforcement at its one end via the first thin steel plate and the first joint part, and to the lower stay for reinforcement at another end via the second thin steel plate and the second joint part,
wherein the first joint part is entirely welded to the upper stay for reinforcement and the second joint part is entirely welded to the lower stay for reinforcement,
wherein the sound insulating board is partially welded respectively to the first thin steel plate and to the second thin steel plate, and
wherein the first thin steel plate is fastened to the first joint part and the second thin steel plate is fastened to the second joint part respectively with a bolt.

6. The stationary induction apparatus according to claim 5, wherein a sealing material is provided so as to cover a circumference of the sound insulating board including welding parts between the sound insulating board and the first thin steel plate and between the sound insulating board and the second thin steel plate.

7. The stationary induction apparatus according to claim 6, wherein in the sealing material, its one end is entirely welded to the first joint part, and another end is entirely welded to the second joint part.
